(19) United States
(12) Patent Application Publication
(10) Pub. No.: US 2005/0024683 A1
(43) Pub. Date: Feb. 3, 2005

(54) Method and apparatus for photo processing and photo-cards printing production

(76) Inventor: K. Clive Liu, Los Altos Hills, CA (US)

Correspondence Address: K. Clive Liu, 25426 Adobe Lane, Los Altos Hills, CA, 94022, US

(21) Appl. No.: 10/856,555

(22) Filed: May 28, 2004

Related U.S. Application Data
(60) Provisional application No. 60/473,723, filed on May 28, 2003.

(51) Int. Cl. G06F 15/00; H04N 1/04

(52) U.S. Cl. 358/1.18; 358/1.12; 358/302

(57) ABSTRACT

The invention provides a method, apparatus, a computer-implemented process, systems and program products for digital photo processing and on-demand photo document printing. The present invention allows a customer to order the photo prints or photo document prints by transferring digital photos or photo documents in electronic formats from the user station to the storage at a photo lab or printing facility. An operator uses the operator station running the program product to compose digital photos and photo documents into one or more photo pages. All processed photo pages of the customer order are sent to one or more desktop printers integrated with a cutting device for imaging on the pre-cut sheet paper. For users in the office or at home, the printing/cutting device accepts page-size (US Letter, A4 etc.) paper. The device prints each photo page, which contains photos or photo document (multiple photos or multiple copies of the photo document), is then cut down to final individual photos or prints to produce photos, post cards, photo cards, and prints business cards.

This application claims priority under 35 USC 119(e) of co-pending provisional application No. 60/473,723 filed May 28, 2003 entitled Method and Apparatus for Digital Photo Processing and On-Demand Photo-Document Printing, hereby incorporated by reference in its entirety.

### BACKGROUND OF THE INVENTION

1. Field of the Invention

This invention relates to the digital photo processing and on-demand photo-document printing; and relates to the photo processing and imaging service business model. This invention also relates to a non-chemical, low-cost and high-performance digital photo processing and on-demand photo-document printing system for photo labs and digital imaging service centers.

2. Background

Today, the worldwide most accessible imaging center is probably the retail photo labs, which has been developed into one single franchised store with different brands known as Kodak, Fuji or other One Hour Photo Labs. With more than 30,000 photo labs in US alone, these photo stores have been the image service center for consumers, professional and commercial customers for processing their film-based photos.

With the popularity of digital cameras and improved digital printing technology, film-based image services have been declining continuously over the past few years. It is believed that most of these photo labs will become digital labs in the next five years to stay competitive.

Digital printing technology is penetrating all segments of the photo, printing and publishing industry. Photo industry started with the silver-halide film-based photo processing system and changed to the digital mini lab system in recent years. Kodak used Noritsu digital silver-halide mini-lab technology with the QSS product line; Konica build its own digital silver-halide mini-lab systems known as QD-21 systems; and Fuji-Film built its own laser technology for digital photo processing known as Frontier. Starting this year, the newest mini lab systems will be built based on the inkjet technologies from Hewlett-Packard and Seiko-Epson.

The prior art of photo processing is based on the silver-halide technology that requires skillful technician to be trained and handle the treatment of chemical waist. Recent inkjet mini-lab systems are moving toward a chemical-free inkjet technology, they still require a rather large space to host the equipment with special power requirements, for example, the system designed by Kodak/Hewlett-Packard. Although, Noritsu/Epson had implemented an inkjet mini-lab system known as dDP-411 that does not require the special power setup, it is still too bulky, too costly and unable to match the performance of its silver-halide counterpart.

Another problem is that of processing the photos by the lab operator. The prior art of photo processing requires the lab operator, typically at the console, to operate the system. The operator checks each photo of the order, from the film or the digital file, makes some light or color adjustments, if necessary, then printed by the mini-lab system sequentially, using several rolls of paper with different widths. In this case, the single mini-lab system needs to be built so it can process and print photos in high-volume, typically 1,200 3R (3.5×5) or 4R (4×6) photos per hour. Today, the inkjet print head used in the new Kodak/Hewlett-Packard or Noritsu/Epson inkjet mini-lab system can only reach about 20% of that productivity offered by the silver-halide mini-lab system. The lab operator performs work with the system the same way as the silver-halide systems, except the inkjet mini-labs only process digital photo files.

It would be advantageous to provide a chemical-free, small, low-cost and high performance system for one-hour photo labs and digital imaging centers in processing photos and printing photo documents. This system is small enough to sit on your desktop in an office environment that does not need a special room with special power requirements. The system is fast enough allowing the order of photos, photo cards, post cards, greeting cards and other photo documents to be completed within one-hour. Since, the system can go anywhere and turn around the printing orders in the matter of hours for the finished photo items, this allows the photo processing and individualized photo-document printing production to be available in all the photos labs and digital imaging service centers.

### SUMMARY OF THE INVENTION

The invention provides a method, apparatus, a computer-implemented process, systems and program products for photo processing and on-demand photo document printing. The invention also provides a business model for photo processing and photo document printing.

The prior art of photo processing has been that each photo is processed individually and imaged sequentially onto one roll paper of the target width. Then, cut each photo to its specified length precisely to produce the finished print. On-demand printing process such as business card/post card printing, however, has to combine several orders; form the impositions of many pages; produce a plate; print (press) on the large roll paper; cut to its final size for each card. The present invention allows photos of the same order to be composed as one or more photo pages, and imaged each photo page onto a pre-cut sheet of paper. Each photo sheet printed, which contains one or more photos, is then cut down to final individual photos. For on-demand photo-document printing, the present invention allows one or more pages of each photo card or business card to be composed as one or more photo pages, and imaged each photo page onto a pre-cut sheet of paper. Each photo sheet contains one or more impressions of the photo document, is then printed and cut down to final individual prints. For both customer orders for photo processing and on-demand photo document printing, the present invention processes each order to produce one or more photo pages and never combines two separate orders to produce the photo sheets. Imaging (printing) is done on a pre-cut sheet, not a roll-paper. Final photo and prints are cut precisely to their final finished sizes by an integrated printing and cutting device.

Another aspect of the invention integrates more than one printing and cutting unit to process the customer orders and imaging each order onto pre-cut sheets by one or more printing and cutting units simultaneously. Instead, the prior art of digital mini-lab system and on-demand photo-document printing used a single, integrated, speedy printing and cutting unit. The photo order requires the operator to process each order and image each photo sequentially. The on-demand, photo-document printing requires the operator to combine more than one order to be economical.

The invention changes how the digital photos and on-demand photo-document prints are made. The prior art of photo processing and on-demand printing system required a large space, and was normally built from one single processing and imaging unit using chemical-based process. The invention integrates several small printers with cutters and a program product to manage each job (order) output on one or more printing and cutting production pipelines. The result is a low-cost, high-performance system that can sit on top of your desktop in a normal office environment.

The invention also provide a business model for photo labs and imaging centers that have been offering the photo processing and imaging services within one-hour to include the film-based and digital photo processing as well as photo document printing services within one-hour.

The foregoing and many other aspects of the present invention will no doubt become obvious to those of ordinary skill in the art after read the following detailed description of the preferred embodiments that are illustrated in the various drawing figures.

### DESCRIPTION OF THE DRAWINGS

FIG. 1 illustrates a conceptual overview of a preferred embodiment the invention;

FIG. 2 illustrates a structure overview and a computer system capable of using the invention in accordance with a preferred embodiment;

FIG. 3 illustrates a schematic showing various equipments that may be utilized at photo lab or imaging service facility in the practice of the method according to the present invention;

FIG. 4 illustrates a high level schematic showing the processing of digital photos ordered by a customer; then processed by an operator pursuant to the method of the present invention;

FIG. 5 illustrates a high level schematic showing the processing and printing photo documents ordered by a customer; then processed by an operator pursuant to the method of the present invention;

FIG. 6 illustrates a schematic showing various equipments, broadband Internet connections and/or other fast communications that may be utilized at photo lab or printing facility in the practice of the method according to the present invention;

### DESCRIPTION OF THE PREFERRED EMBODIMENTS

### Detailed Description

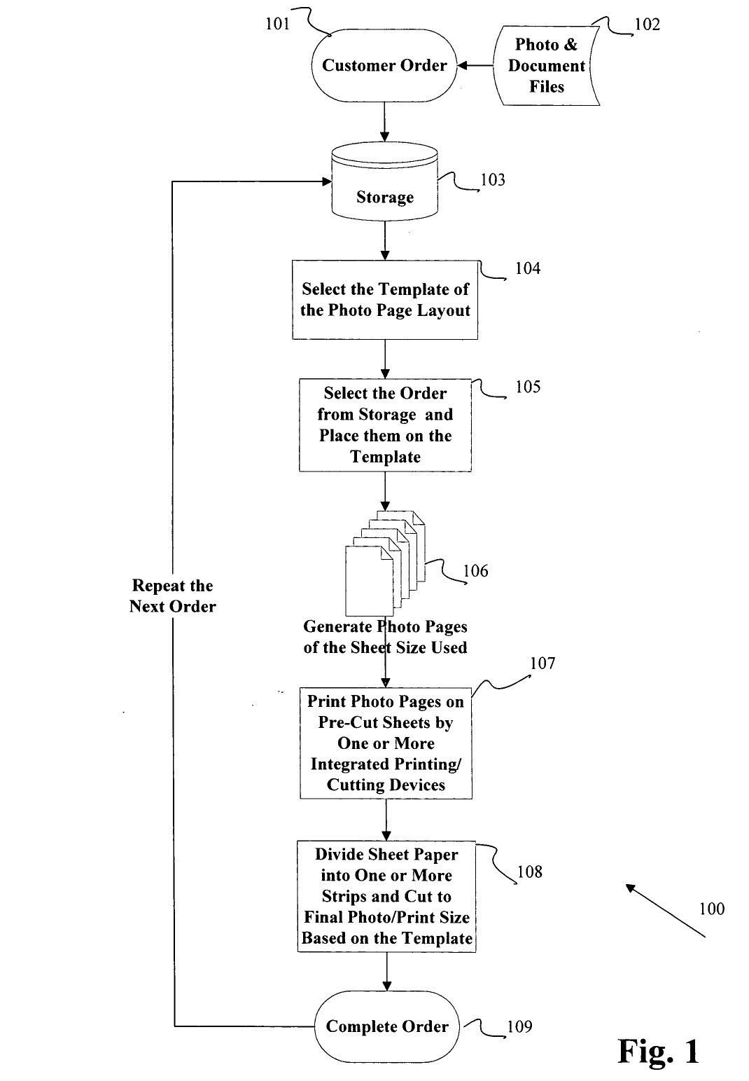

FIG. 1 illustrates a conceptual overview of a preferred embodiment the invention, indicated by general reference character 100, for processing digital photos and on-demand photo document prints. A customer order 101 containing one or more digital photos or photo documents in electronic format 102, are transferred to a storage 103. At step 104, a program product selects the template of a photo page layout based on the photo or photo document size required and the printing sheet size used. At step 105, the program product selects the order and place the photo or document files on the template. The transferred file(s) 102 are composed into one or more photo pages 106 for the sheet size used. At step 107, the program product prints photo pages 106 on one or more integrated printing/cutting devices using pre-cut sheet paper. At step 108, each printing/cutting device divides the printed portion of the sheet into one or more strips, then cut them into final photo or print size according to the layout and dimension of the template; and completed the printing production for the order at step 109. For the next order, the above steps repeat at a customer order on the storage 103.

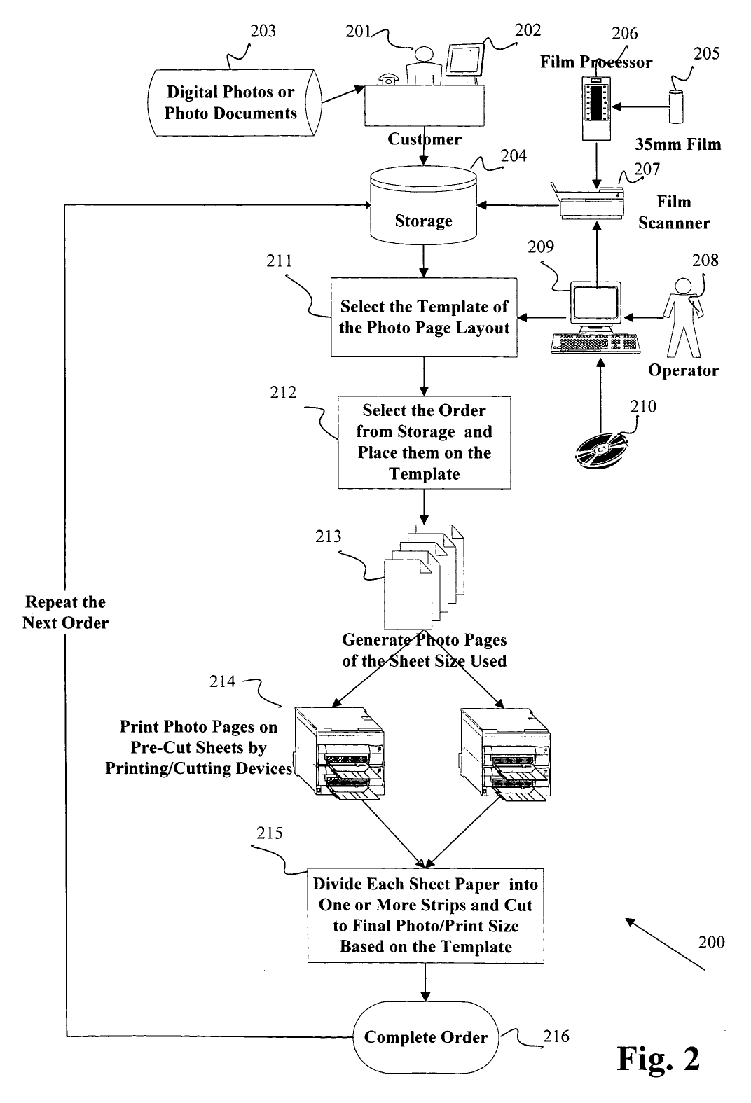

FIG. 2 illustrates a structure overview and a computer system capable of using the invention in accordance with a preferred embodiment, indicated by general reference character 200, for processing photos and photo documents in a photo lab or imaging service facility. A customer 201 selects one or more digital photos or photo documents at the user station 202. The order and the digital photos or photo documents 203 are transferred to the storage 204. If a customer 201 drops off a 35 mm film, the film 205 gets developed by a film processor 206 and scanned to the storage 204 by a film scanner 207. The operator 208 at the operator station 209 running the program product 210 processes the order. At the step 211, the operator 208 inspects each photo or photo document of the order and selects the template of the photo page layout based on the size of the photo or document print required, and the size of the sheet paper used during the printing. At the step 212, the operator 208 selects the file from the storage 204 and places them on the template chosen. Digital photos or photo documents are composed into one or more photo pages 213 in the sheet size used based on the number of copies (multiple photos or multiple copies of the photo document) ordered. One or more photo pages 213 are then sent to one or more integrated printing/cutting devices 214 for printing on the pre-cut sheet paper. At step 215, each printing/cutting device divides the printed portion of the sheet into one or more strips, then cut them into final photo or print size according to the layout and dimension of the template; and completed the printing production for the order at step 216. For the next order, the above steps repeat at a customer order on the storage 204.

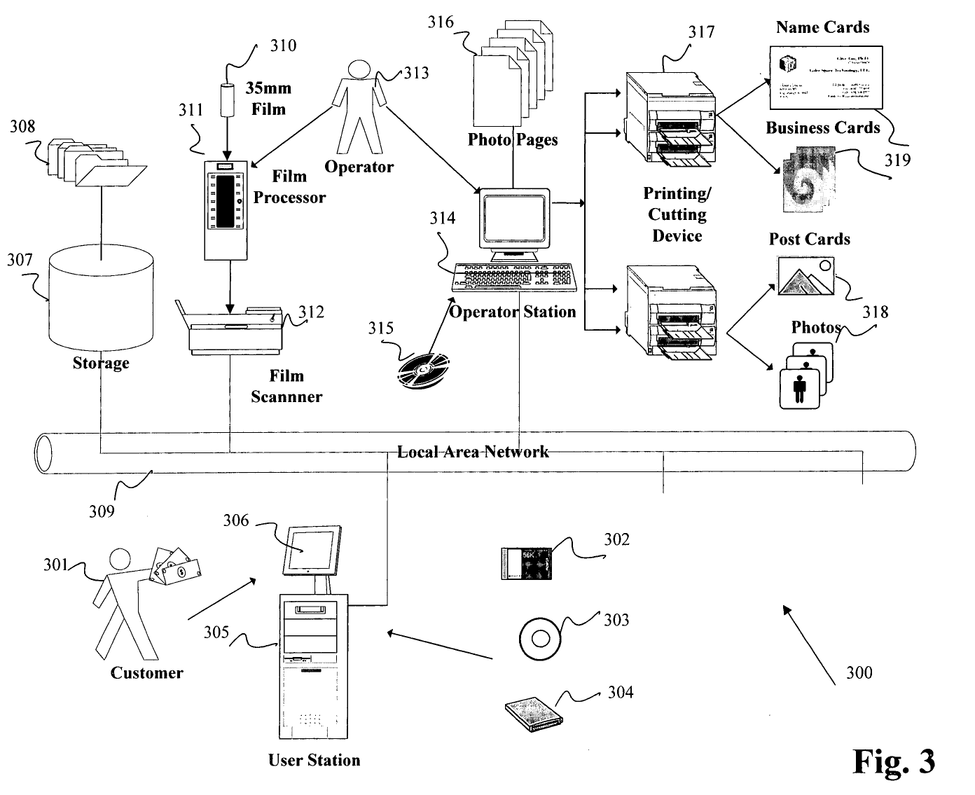

FIG. 3 illustrates a schematic showing various equipments that may be utilized at photo lab or imaging service facility in the practice of the method according to the present invention, indicated by general reference character 300. A customer 301 brings in digital camera storage media such as Smart Media 302, Compact Disk 303 and other storage media 304 that contains digital photos or photo documents in electronic formats. A user station 305 can be used for customers to preview/edit their digital photos, photo documents and other files. Customers insert the media that contains photos or photo documents into the user station 305. Through the display 306, the customer selects the photos and photo documents to be processed for printing. Electronic files of the digital photos or photo documents for each order are transferred from the customer's media to the photo lab or imaging service facility storage 307 as a group of image files in separate folders 308. The storage 307 can be located on the user station 305 or on other machine connected by a local area network 309. If a customer 301 drops off a 35 mm film, the film 310 gets developed by a film processor 311 and scanned to the storage 307 by a film scanner 312. The operator 313 processes each order by accessing the storage 307 through the operator station 314 running the program product 315 to compose the digital photos, or the photo documents into one or more photo pages 316. The size of each photo page can be a standard page size (US Letter or A4) or a pre-defined customized size to match with the pre-cut sheets used. Alternative template layouts are used in processing the order based on the size of the photos or prints ordered, and the size of sheets used. The number of photo pages 316 generated is based on the number of copies (multiple photos or multiple copies of the photo document) ordered. One or more photo pages 316 are then sent to one or more integrated printing/cutting devices 317 for printing on the pre-cut sheet paper and producing the final finished size of individual photos, post cards 318, or the final finished size of prints for the business cards or name cards 319.

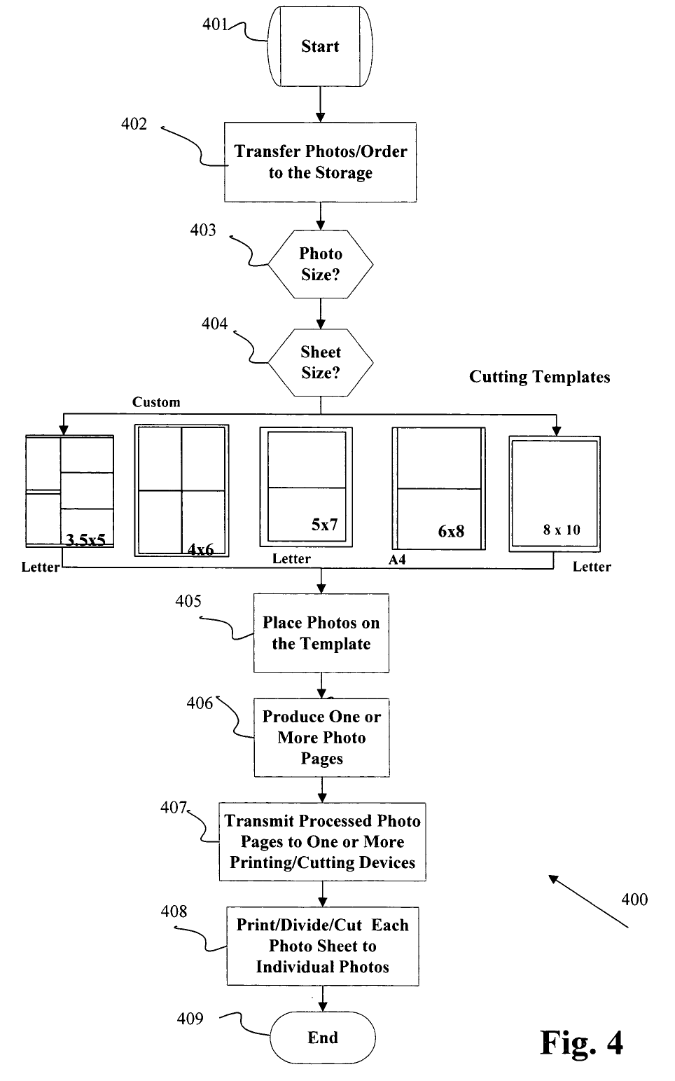

FIG. 4 illustrates a high level schematic showing the processing of digital photos ordered by a customer; then processed by an operator indicated by general reference character 400

The process 400 initiates at a “start” terminal 401 when a customer selects one or plurality of digital photos for ordering the photo prints. At the step 402, the order information and digital photos in electronic format are transferred to a storage at separate locations for the order with different photo sizes, for example, separate folders of 3.5″×5″, 4″×6″, 5″×7″ etc. A “Photo Size” decision step 403 and a “Sheet Size” decision step 404 select the cutting template to determine how the digital photos will be processed into one or more photo pages for the order. At the step 405, place the photos of one order from the location containing photos of the same size on the cutting template. At the step 406, these digital photo files are composed into one or more photo pages of the sheet size used, from the electronic files on the storage at the same photo size location. At the step 407, the processed photo pages are sent to one or more printing/cutting devices with correct size sheets installed. At the step 408, each sheet is printed, divided into one or more strips, then cut into final size photos. The process 400 completes through an “end” terminal 409.

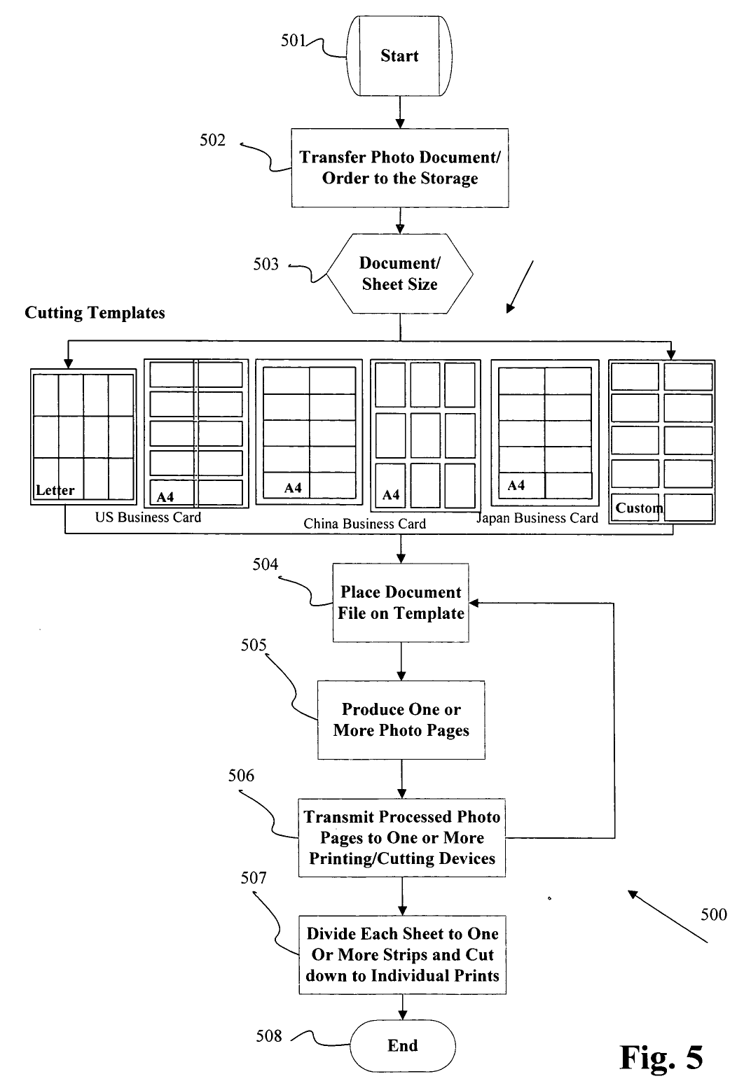

FIG. 5 illustrates a high level schematic showing the processing and printing photo documents such as post cards; photo cards, business cards and name cards ordered by a customer, and processed by an operator indicated by general reference character 500.

The process 500 initiates at a “start” terminal 501 when a customer has selected one or plurality of electronic files (photo documents) as one order. At the step 502, the order information and the electronic files are transferred to a storage at separate locations for the order with different card sizes, for example, separate folders of 3.5″×5″, 4″×6″, 5″×7″ etc. for photo and post cards; 51 mm×89 mm, 90 mm×55 mm, 91 mm×55 mm for US, Chinese and Japanese business/name cards. A “Document Size and Sheet Size” decision step 503 selects the cutting template to determine how each electronic file will be processed into one or more photo pages for the order. At the step 504, place the document file from the location containing electronic files of the same document size on the cutting template. At the step 505, these digital document files are composed into one or more photo pages with the required print quantity, from the electronic file on the storage at the same document size location. At the step 506, the processed photo pages are sent to one or more printing/cutting devices with correct size sheets installed. The photo document printing process 500 continues to the “Place Document File on Cutting Template” step 504 for next photo document file. At the step 507, each sheet is divided into one or more strips, cut into final size document prints. The process 500 completes through an “end” terminal 508.

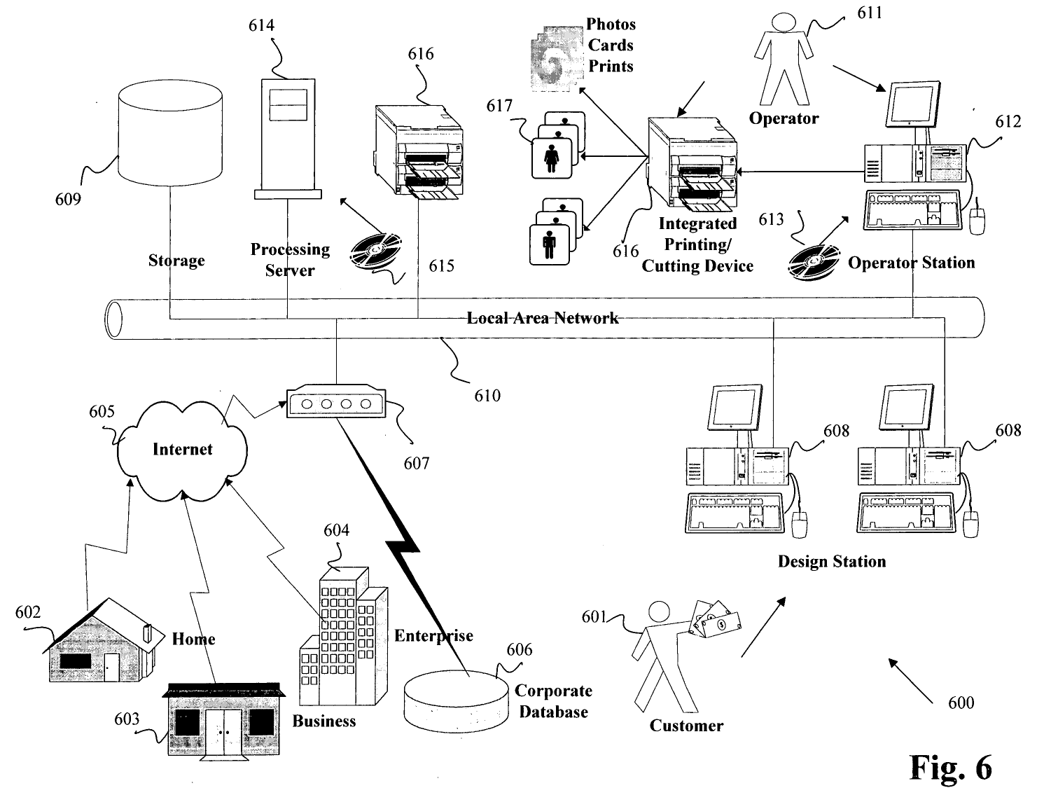

FIG. 6 illustrates a schematic showing various equipments, broadband Internet connections and/or other fast communications that may be utilized at photo lab or imaging service facility in the practice of the method according to the present invention, indicated by general reference character 600. A customer 601 sends in an order that contains digital photos or photo documents in electronic formats from home 602, business 603 and enterprise 604 via Internet 605 or directly from the corporate database 606 through high-speed modem 607. A customer 601 can also make the order by using the design station 608 at photo lab or imaging service facility to select and edit the digital photos and photo documents. Customer orders that contains digital photos or photo documents in electronic formats are transferred to the storage 609 on the local area network 610. All orders are processed by the operator 611 via the operator station 612 running a program product 613, or processed automatically via the processing server 614 running a server program product 615 by accessing the storage 609 to compose the digital photos, or the photo document file into one or more photo pages. The size of each photo page is a standard page size (US Letter or A4) or a pre-defined customized size to match with the pre-cut sheet size. The processed photo pages are then sent to one or more integrated printing/cutting devices 616 using the page-size, pre-cut sheets to produce the final finished size of individual photos, cards or document print 617.

One skilled in the art will understand that the invention provides a flexible and efficient method and apparatus for processing both film-based and digital photos as well as on-demand photo document printing.

From the foregoing, it will be appreciated that the invention has (without limitation) the following advantages:

1) For a photo lab or image service facility, the invention provides a valuable, low-cost, productive system for film/digital photo processing and on-demand photo document printing services;

2) A film-less digital photo lab system and plate-less on-demand printing press that is chemical-free and no need of special power and environment requirements;

3) A system that is small and flexible to be used anywhere. The invention provides a desktop system, connecting with the Internet, it would become a truly distributed system for digital photo processing and on-demand photo document printing;

4) The invention allows small inkjet printers used at home or office to become a most cost-effective system for digital photo processing and on-demand photo document printing using the standard page-size photo or card paper.

While the invention has been herein shown and described in what is presently conceived to be the most practical and preferred embodiment thereof, it will be apparent to those of ordinary skill in the art that many modifications may be made thereof which scope is to be accorded the broadest interpretation of the appended claims so as to encompass all equivalent methods and processes.

Although the present invention has been described in terms of the presently preferred embodiments, various modifications and alterations can be made without departing from the scope of the invention. Accordingly, the scope of the invention is not to be limited to the particular invention embodiments discussed herein, but should be defined only by the appended claims and their equivalents.

1. A method and apparatus of processing photos using pre-cut sheets; one or more printers integrated with cutting functions; program product and computer station; said method and apparatus comprising the steps of:
(a) Receiving digital photos and transferring digital photos to a storage at photo lab or imaging service facility;
(b) At a computer station running the program product, composing digital photos as one or more photo pages of the sheet size and the cutting template selected;
(c) Transmitting one or more photo pages to one or more printing/cutting devices and produce the final size of photos by dividing each pre-cut sheet into one or more strips and cutting to finished size of each photo.

2. The apparatus of claim 1, further including to receive photos from customers at photo lab or imaging service facility using a user station and transferring the photos to a storage; at an operator station running the program product to compose the order as one or more photo pages of the sheet size and the cutting template selected for the photo size ordered; transmitting one or more photo pages to one or more printing/cutting devices and produce the final size of photos.

3. The apparatus of claim 1, further including to receive photos from customers at the imaging service facility by processing photos from films using a film processing unit, scanning device and transferring the digital photos (digitized images) to a storage; at an operator station running the program product to compose the order as one or more photo pages of the sheet size and the cutting template selected for the photo size ordered; transmitting one or more photo pages to one or more printing/cutting devices and produce the final size of photos.

4. The method of claim 1, further including a program product running on a station connected to a printer for processing digital photo in-house using standard page-size (US Letter, A4 etc.) or custom-size sheets; comprising the steps of:
At the station, selecting the cutting template of the photo page layout determined by the photo size and the standard page-size or custom-size sheets used for machine to cut each photo from sheet;
At the station, selecting the digital photos as a group for processing; placing them on the cutting template to produce one or more photo pages of the page-size or custom-size sheets used;
At the station, previewing each photo page and editing individual photo;
At the station, transmitting one or more photo pages to print on the printer then cut to the finished size of photos by a separate cutting device designed with the specification of the cutting template used.

5. The method of claim 1, further including a digital imaging service model utilizing the method, apparatus, computer-implemented process, systems and program products for photo processing; comprising the steps of:
A customer sends in an order that contains digital photos from home, business via Internet through high-speed Internet.
A customer can also make the order by using the design station at photo lab or imaging service facility to select and edit the digital photos.
The system transfers digital photos as one customer order to a storage;
Each customer order is processed by a processing server running the program product (server) or by an operator via the operator station running the program product (client) on the network;
The program product composes each customer order as one or more photo pages by selecting the cutting template of the page layout based on the size of the photos or prints required, size of the pre-cut sheets used and the quantity ordered;
Photo pages of each customer order are sent to one or more printing/cutting devices using pre-cut sheets with matching size to produce the final size of photos by dividing sheet into one or more strips, then cutting into individual prints according to the cutting template used.

6. A method and apparatus of processing photo cards using pre-cut sheets; one or more printers integrated with cutting functions; program product and computer station; said method and apparatus comprising the steps of:
(a) Receiving photo card documents in electronic format and transferring photo card documents to a storage at photo lab or imaging service facility;
(b) At a computer station running the program product, composing each page of the photo card document as one or more print pages according to the quantity of cards ordered, the sheet size and the cutting template selected;
(c) Transmitting one or more print pages to one or more printing/cutting devices and produce the final size of photo card prints by dividing each pre-cut sheet into one or more strips and cutting to finished size of each card.

7. The apparatus of claim 6, further including to receive photo card documents in electronic format from customers at photo lab or imaging service facility using a user station and transferring the photo documents to a storage; at an operator station running the program product to preview, edit and compose each page of the photo document as one or more print pages of the sheet size and the cutting template selected for the print size ordered; transmitting one or more print pages to one or more printing/cutting devices and produce the final size of photo cards.

8. The apparatus of claim 6, further including to receive actual photo card from customers at the imaging service facility by scanning photo card using a scanning device and transferring the digitized images to a storage; at an operator station running the program product to review, edit and compose the order as one or more print pages of the sheet size and the cutting template selected for the photo card size ordered; transmitting one or more print pages to one or more printing/cutting devices and produce the final size of photo cards.

9. The method of claim 6, further including a program product running on a station connected to a printer for processing photo card in-house using standard page-size (US Letter, A4 etc.) or custom-size sheets; comprising the steps of:
At the station, scanning or designing a photo card for reproduction, saving it as a photo card document in electronic format;
At the station, selecting the cutting template of the print page layout determined by the photo card size and the standard page-size or custom-size sheets used for machine to cut each photo card from sheet;
At the station, selecting the photo card document for processing; placing them on the cutting template to produce one or more print pages based on the quantity of photo cards required of the page-size or custom-size sheets
At the station, transmitting one or more print pages to print on the printer then cut to the finished size of photo cards by a separate cutting device designed with the specification of the cutting template used.

10. The method of claim 6, further including a digital imaging service model utilizing the method, apparatus, computer-implemented process, systems and program products for photo card document processing; comprising the steps of:
A customer sends in an order that contains photo card documents in electronic format from home, business via Internet through high-speed Internet;
A customer can also make the order by using the design station at photo lab or imaging service facility to design, edit and select the photo card documents;
The system transfers photo card documents to storage;
Each photo card document is processed by a processing server running the program product (server) or by an operator via the operator station running the program product (client) on the network;
The program product composes each photo card document as one or more print pages by selecting the cutting template of the page layout based on the size of the photo card required, size of the pre-cut sheets used and the quantity ordered;
Print pages of each photo card document are sent to one or more printing/cutting devices using pre-cut sheets with matching size to produce the final size of photo cards by dividing each sheet into one or more strips, then cutting into individual cards according to the cutting template used.

11. A program product for photo processing using pre-cut sheets; selecting the template for machine to cut each photo from sheet; generating one or more image pages and transmitting to one or more printing/cutting devices; comprising the steps of:
Selecting the cutting template of the photo page layout determined by the photo size and the size of the pre-cut sheets used for machine to cut each photo from sheet;
Selecting the digital photos as a group; placing them on the template to produce one or more photo pages of the sheet size used;
Transmitting one or more photo pages to one or more printing/cutting devices to produce the finished size of photos and complete the job.

12. The program product of claim 11, wherein said cutting template includes templates for all photo sizes 1 3/16″×2 ⅜″ ID photo, 2″ passport photo, wallet-size photo, 3.5″×5″, 4″×6″, 5″×7″, 6″×8″ and 8″×10″ and other sizes using standard page-size (US Letter, A4) or custom-size pre-cut sheets.

13. The program product of claim 11, wherein said cutting template is determined by selecting photo size ordered and pre-cut sheets installed on the printing/cutting devices capable of processing the photos using the cutting template;

14. The computer controlled method of claim 11, wherein said photo pages of the pre-cut sheet size using the cutting template are generated by placing the selected photos from the storage on the cutting template; all the digital photos are layed down properly with each photo orientation, photo scaling, photo cropping to compose the said photo pages;

15. The computer controlled method of claim 11, wherein said photo pages generated for the photos are transmitting to one or more printing/cutting devices by printing each photo page, dividing into one or more strips, and cutting into final size of each photo.

16. The program product of claim 11 for photo card document processing using pre-cut sheets; selecting the template for machine to cut each photo card from sheet; generating one or more image pages and transmitting to one or more printing/cutting devices; comprising the steps of:
Selecting the cutting template of the photo card page layout determined by the photo card size and the size of the pre-cut sheets used for machine to cut each photo from sheet;
Selecting the each page of the photo card document; placing them on the template to produce one or more photo card pages of the sheet size used;
Transmitting one or more photo card pages to one or more printing/cutting devices to produce the finished size of photo cards and complete the job.

17. The program product of claim 16, wherein said cutting template includes templates for all photo card sizes 2.5″×3.5″, 3.5″×5″, 4″×6″, 5″×7″, 6″×8″ or 51 mm×89 mm, 90 mm×55 mm, 91 mm×55 mm for US, Chinese and Japanese business/name cards using standard page-size (US Letter, A4) or custom-size pre-cut sheets.

18. The program product of claim 16, wherein said cutting template is determined by selecting photo card size ordered and pre-cut sheets installed on the printing/cutting devices capable of processing the photo cards using the cutting template;

19. The computer controlled method of claim 16, wherein said photo card pages of the pre-cut sheet size using the cutting template are generated by placing the selected photo card document from the storage on the cutting template; a page of the photo card document is replicated properly with each photo card orientation, photo card scaling, photo card cropping to compose the said photo card pages;

20. The computer controlled method of claim 16, wherein said photo card pages generated for the photos are transmitting to one or more printing/cutting devices by printing each photo card page, dividing into one or more strips, and cutting into final size of each photo card.
